(19) United States
(12) Patent Application Publication
(10) Pub. No.: US 2024/0331310 A1
(43) Pub. Date: Oct. 3, 2024

(54) AUGMENTED REALITY GUIDANCE IN A PHYSICAL LOCATION

(71) Applicant: QUALCOMM Incorporated, San Diego, CA (US)

(72) Inventors: Avinash SHRIVASTAVA, Hyderabad (IN); Liangping MA, San Diego, CA (US)

(21) Appl. No.: 18/191,469

(22) Filed: Mar. 28, 2023

(51) Int. Cl. G06T 19/00; G09F 3/20; H04W 64/00

(52) U.S. Cl. CPC G06T 19/006; G09F 3/208; H04W 64/006

(57) ABSTRACT

In some aspects, a server device associated with a physical location may receive a message from a user device associated with a user, the message identifying a target located at the physical location and the message including an indication of a current location of the user device within the physical location. The server device may transmit, responsive to the message, a model to the user device, the model configured to cause presentation of one or more augmented reality elements to guide the user through the physical location from the current location to the target. The server device may cause an electronic shelf label (ESL) associated with the target to activate an indicator. Numerous other aspects are described.

### FIELD OF THE DISCLOSURE

Aspects of the present disclosure generally relate to extended reality and, for example, to augmented reality guidance in a physical location.

### BACKGROUND

Short range wireless communication enables wireless communication over relatively short distances (e.g., within 30 meters). For example, BLUETOOTH® is a wireless technology standard for exchanging data over short distances using short-wavelength ultra high frequency (UHF) radio waves from 2.4 gigahertz (GHz) to 2.485 GHz. BLUETOOTH® Low Energy (BLE) is a form of BLUETOOTH® communication that allows for communication with devices running on low power. Such devices may include beacons, which are wireless communication devices that may use low-energy communication technology for locationing, proximity marketing, or other purposes. Furthermore, such devices may serve as nodes (e.g., relay nodes) of a wireless mesh network that communicates and/or relays information to a managing platform or hub associated with the wireless mesh network.

### SUMMARY

Some aspects described herein relate to a method. The method may include receiving, by a server device associated with a physical location, a message from a user device associated with a user, the message identifying a target located at the physical location and the message including an indication of a current location of the user device within the physical location. The method may include transmitting, by the server device and responsive to the message, a model to the user device, the model configured to cause presentation of one or more augmented reality elements to guide the user through the physical location from the current location to the target. The method may include causing, by the server device, an electronic shelf label (ESL) associated with the target to activate an indicator.

Some aspects described herein relate to a device. The device may include a memory and one or more processors coupled to the memory. The one or more processors may be configured to receive a message from a user device associated with a user, the message identifying a target located at a physical location and the message including an indication of a current location of the user device within the physical location. The one or more processors may be configured to transmit, responsive to the message, a model to the user device, the model configured to cause presentation of one or more augmented reality elements to guide the user through the physical location from the current location to the target. The one or more processors may be configured to receive, from the user device, a response message indicating whether a loading of the model is successful.

Some aspects described herein relate to an apparatus. The apparatus may include means for receiving a message from a user device associated with a user, the message identifying a target located at a physical location and the message including an indication of a current location of the user device within the physical location. The apparatus may include means for transmitting, responsive to the message, a model to the user device, the model configured to cause presentation of one or more augmented reality elements to guide the user through the physical location from the current location to the target.

Some aspects described herein relate to a non-transitory computer-readable medium that stores a set of instructions by a user device. The set of instructions, when executed by one or more processors of the user device, may cause the user device to transmit a message to a server device associated with a physical location, the message identifying a target located at the physical location and the message including an indication of a current location of the user device within the physical location. The set of instructions, when executed by one or more processors of the user device, may cause the user device to receive, responsive to the message, a model from the server device, the model configured to cause presentation of one or more augmented reality elements to guide a user through the physical location from the current location to the target. The set of instructions, when executed by one or more processors of the user device, may cause the user device to transmit, to the server device, a response message indicating whether a loading of the model is successful.

Aspects generally include a method, apparatus, system, computer program product, non-transitory computer-readable medium, user device, user equipment, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram of an example environment in which systems and/or methods described herein may be implemented.

FIG. 2 is a diagram illustrating example components of a device, in accordance with the present disclosure.

FIGS. 3A-3E are diagrams illustrating an example associated with augmented reality (AR) guidance in a physical location, in accordance with the present disclosure.

FIG. 4 is a flowchart of an example process associated with AR guidance in a physical location.

FIG. 5 is a flowchart of an example process associated with AR guidance in a physical location.

FIG. 6 is a flowchart of an example process associated with AR guidance in a physical location.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

An electronic shelf label (ESL) is an electronic display (e.g., an electronic paper (c-paper) display or a liquid-crystal display (LCD)), which may be used to display information pertaining to a nearby item, room, area, or the like. For example, ESLs may be used on retail shelves to display product details, such as price. An ESL system may include a management entity (ME), which may be cloud-based, that provides control of one or more ESLs. To facilitate control by the ME, each ESL may have a wireless connection (e.g., a BLUETOOTH® Low Energy (BLE) connection) to an access point (AP) that is communicatively connected to the ME (e.g., via the Internet). Thus, commands from the ME may be wirelessly transmitted to the ESL by the AP. In one example, the ME may store product details (e.g., prices), which the ME may control and/or dynamically change. Thus, the AP may retrieve product details from the ME, and the AP may communicate the product details to one or more ESLs for display by the ESL(s).

A physical location, such as a retail store, may employ multiple ESLs that are distributed throughout the physical location. In some examples, an individual may use an AR device to navigate through the physical location. However, navigation data relating to the physical location may be statically stored on the AR device. As a result, the navigation data may become outdated or otherwise inaccurate. Accordingly, the AR device may expend significant computing resources (e.g., processor resources, memory resources, or the like) using inaccurate data. Moreover, to enable use of the AR device in connection with multiple physical locations, the AR device may store separate navigation data for each location, thereby consuming significant storage resources of the AR device. In some cases, the navigation data may be sufficient to guide the user to a vicinity of an item of interest to the user, but the user may be unable to locate the item once there. Thus, while the user spends additional time scanning the vicinity attempting to locate the item of interest, the AR device may continue to capture and process camera data, thereby expending excessive computing resources.

Some techniques and apparatuses described herein enable communication between a user device (e.g., an AR device) and a server device associated with a physical location to facilitate the downloading of a model by the user device. For example, the user device may provide a request indicating a user's target of interest (e.g., an item or an area) located at the physical location and a current location, and responsive to the request, the server device may prepare and transmit a model to the user device in accordance with the target and the current location. The model may be configured to cause presentation of AR elements to guide the user through the physical location from the current location to the target. Moreover, the model may be particular to the physical location and/or particular to the target. In this way, the user device may obtain a fresh model each time the user visits a physical location and/or requests a new target, thereby improving the efficiency and the accuracy of the AR guidance and reducing a storage burden on the user device. In some aspects, the server device may cause an ESL associated with the target to activate an indicator (e.g., by blinking a light) that facilitates faster location of the target. Accordingly, the user device may conserve computing resources that may have otherwise been expended capturing and processing camera data for an extended time period.

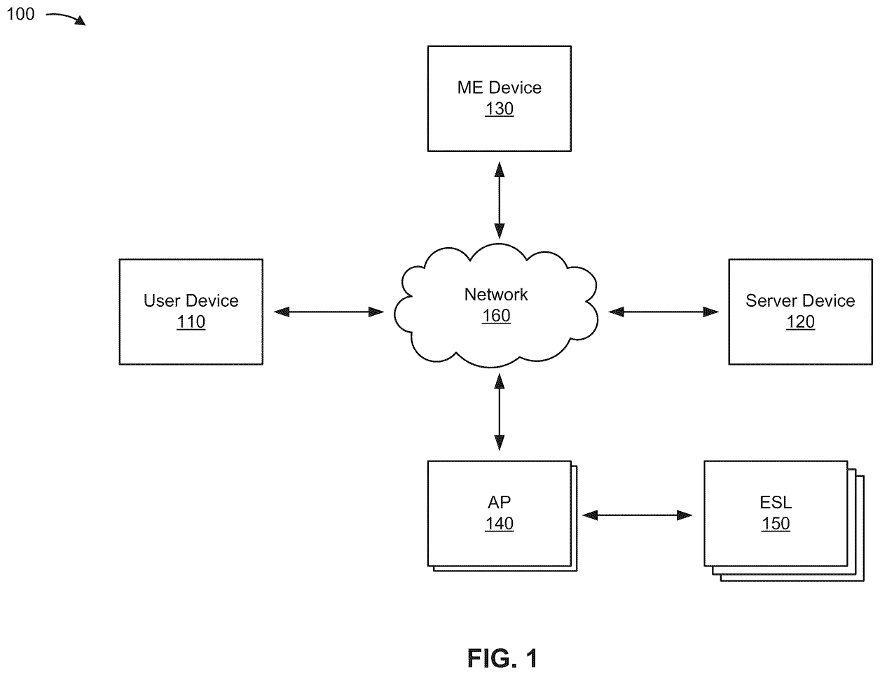

FIG. 1 is a diagram of an example environment 100 in which systems and/or methods described herein may be implemented. As shown in FIG. 1, environment 100 may include a user device 110, a server device 120, an ME device 130, an AP 140, an ESL 150, and a network 160. Devices of environment 100 may interconnect via wired connections, wireless connections, or a combination of wired and wireless connections.

The user device 110 may include one or more devices capable of receiving, generating, storing, processing, and/or providing information associated with AR guidance in a physical location, as described elsewhere herein. The user device 110 may include a communication device and/or a computing device. For example, the user device 110 may include a wireless communication device, a mobile phone, a user equipment, a laptop computer, a tablet computer, a wearable communication device (e.g., an AR device, such as a head mounted display (HMD)), or a similar type of device.

The server device 120 may include one or more devices capable of receiving, generating, storing, processing, providing, and/or routing information associated with AR guidance in a physical location, as described elsewhere herein. The server device 120 may include a communication device and/or a computing device. For example, the server device 120 may include a server, such as an application server, a client server, a web server, a database server, a host server, a proxy server, a virtual server (e.g., executing on computing hardware), or a server in a cloud computing system. In some aspects, the server device 120 may include computing hardware used in a cloud computing environment.

The ME device 130 includes one or more devices capable of receiving, generating, storing, processing, providing, and/or routing information associated with control of one or more ESLs 150, as described elsewhere herein. The ME device 130 may include a communication device and/or a computing device. For example, the ME device 130 may include a server, such as an application server, a client server, a web server, a database server, a host server, a proxy server, a virtual server (e.g., executing on computing hardware), or a server in a cloud computing system. In some aspects, the ME device 130 includes computing hardware used in a cloud computing environment. The ME device 130 may provide control of a system (e.g., an ESL system) that includes one or more APs 140 and one or more ESLs 150. For example, the ME device 130 may implement an ME for the system.

The AP 140 may include one or more devices capable receiving, generating, storing, processing, providing, and/or routing information associated with control of one or more ESLs 150, as described elsewhere herein. The AP 140 may include a communication device and/or a computing device. The AP 140 may facilitate communication between the ME device 130 and one or more ESLs 150.

The ESL 150 may include one or more devices capable of receiving. generating, storing, processing, and/or providing information associated with control of the ESL 150, as described elsewhere herein. The ESL 150 may include a communication device and/or a computing device. In some aspects, the ESL 150 may include a display (e.g., an e-paper display). The ESL 150 may communicate with the AP 140 via a Bluetooth network or another type of personal area network.

The network 160 may include one or more wired and/or wireless networks. For example, the network 160 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 160 enables communication among the devices of environment 100.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of environment 100 may perform one or more functions described as being performed by another set of devices of environment 100.

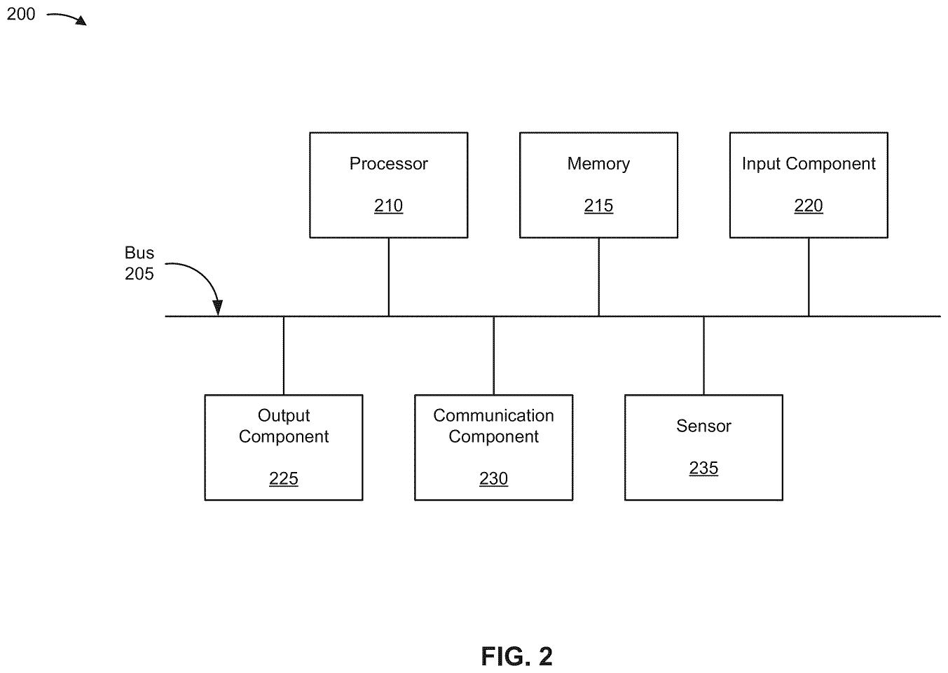

FIG. 2 is a diagram illustrating example components of a device 200, in accordance with the present disclosure. The device 200 may correspond to user device 110, server device 120, ME device 130, AP device 140, and/or ESL 150. In some aspects, user device 110, server device 120, ME device 130, AP device 140, and/or ESL 150 may include one or more devices 200 and/or one or more components of the device 200. As shown in FIG. 2, the device 200 may include a bus 205, a processor 210, a memory 215, an input component 220, an output component 225, a communication component 230, and/or a sensor 235.

The bus 205 may include one or more components that enable wired and/or wireless communication among the components of the device 200. The bus 205 may couple together two or more components of FIG. 2, such as via operative coupling, communicative coupling, electronic coupling, and/or electric coupling. For example, the bus 205 may include an electrical connection (e.g., a wire, a trace, and/or a lead) and/or a wireless bus. The processor 210 may include a central processing unit, a graphics processing unit, a microprocessor, a controller, a microcontroller, a digital signal processor, a field-programmable gate array, an application-specific integrated circuit, and/or another type of processing component. The processor 210 may be implemented in hardware, firmware, or a combination of hardware and software. In some aspects, the processor 210 may include one or more processors capable of being programmed to perform one or more operations or processes described elsewhere herein.

The memory 215 may include volatile and/or nonvolatile memory. For example, the memory 215 may include random access memory (RAM), read only memory (ROM), a hard disk drive, and/or another type of memory (e.g., a flash memory, a magnetic memory, and/or an optical memory). The memory 215 may include internal memory (e.g., RAM, ROM, or a hard disk drive) and/or removable memory (e.g., removable via a universal serial bus connection). The memory 215 may be a non-transitory computer-readable medium. The memory 215 may store information, one or more instructions, and/or software (e.g., one or more software applications) related to the operation of the device 200. In some aspects, the memory 215 may include one or more memories that are coupled (e.g., communicatively coupled) to one or more processors (e.g., processor 210), such as via the bus 205. Communicative coupling between a processor 210 and a memory 215 may enable the processor 210 to read and/or process information stored in the memory 215 and/or to store information in the memory 215.

The input component 220 may enable the device 200 to receive input, such as user input and/or sensed input. For example, the input component 220 may include a touch screen, a keyboard, a keypad, a mouse, a button, a microphone, a switch, a sensor, a global positioning system (GPS) sensor, a global navigation satellite system sensor, an accelerometer, a gyroscope, and/or an actuator. The output component 225 may enable the device 200 to provide output, such as via a display, a speaker, and/or a light-emitting diode. For example, the ESL 150 may include a display, a light source, and/or a speaker. The communication component 230 may enable the device 200 to communicate with other devices via a wired connection and/or a wireless connection. For example, the communication component 230 may include a receiver, a transmitter, a transceiver, a modem, a network interface card, and/or an antenna.

The sensor 235 includes one or more devices capable of detecting a characteristic associated with the device 200 (e.g., a characteristic relating to a physical environment of the device 200 or a characteristic relating to a condition of the device 200). The sensor 235 may include one or more photodetectors (e.g., one or more photodiodes), one or more cameras, one or more microphones, one or more gyroscopes (e.g., a micro-electro-mechanical system (MEMS) gyroscope), one or more magnetometers, one or more accelerometers, one or more location sensors (e.g., a GPS receiver or a local position system (LPS) device), one or more motion sensors, one or more temperature sensors, one or more pressure sensors, and/or one or more touch sensors, among other examples. For example, the user device 110 may include a camera.

The device 200 may perform one or more operations or processes described herein. For example, a non-transitory computer-readable medium (e.g., memory 215) may store a set of instructions (e.g., one or more instructions or code) for execution by the processor 210. The processor 210 may execute the set of instructions to perform one or more operations or processes described herein. In some aspects, execution of the set of instructions, by one or more processors 210, causes the one or more processors 210 and/or the device 200 to perform one or more operations or processes described herein. In some aspects, hardwired circuitry may be used instead of or in combination with the instructions to perform one or more operations or processes described herein. Additionally, or alternatively, the processor 210 may be configured to perform one or more operations or processes described herein. Thus, aspects described herein are not limited to any specific combination of hardware circuitry and software.

In some aspects, device 200 may include means for receiving, a message from a user device associated with a user, the message identifying a target located at a physical location and the message including an indication of a current location of the user device within the physical location; means for transmitting, responsive to the message, a model to the user device, the model configured to cause presentation of one or more augmented reality elements to guide the user through the physical location from the current location to the target; and/or means for causing an ESL associated with the target to activate an indicator. In some aspects, the means for device 200 to perform processes and/or operations described herein may include one or more components of device 200 described in connection with FIG. 2, such as bus 205, processor 210, memory 215, input component 220, output component 225, communication component 230, and/or sensor 235.

The number and arrangement of components shown in FIG. 2 are provided as an example. The device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

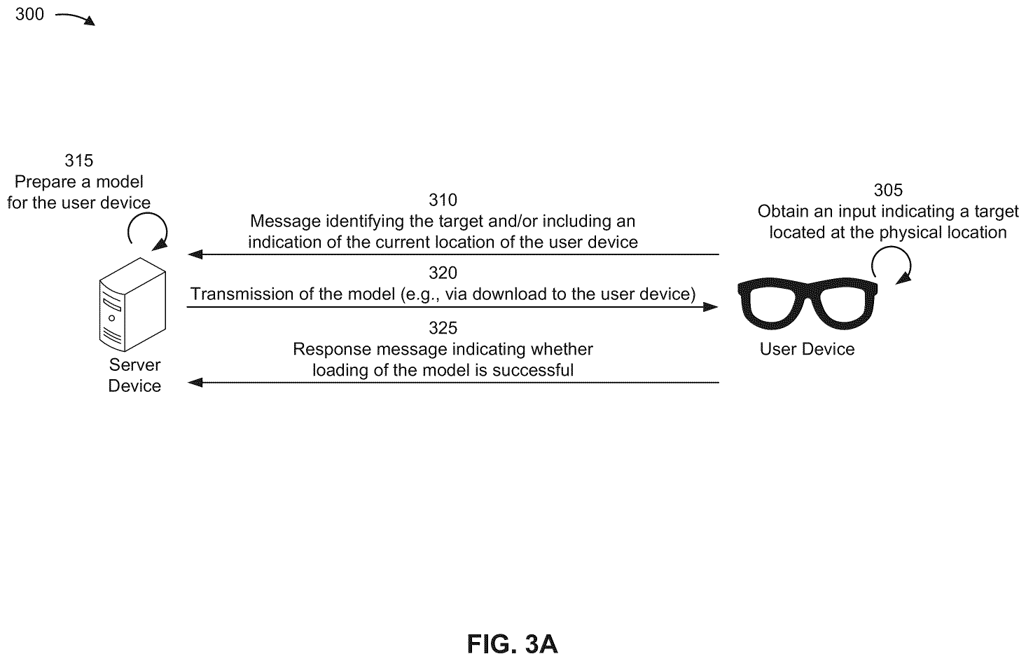

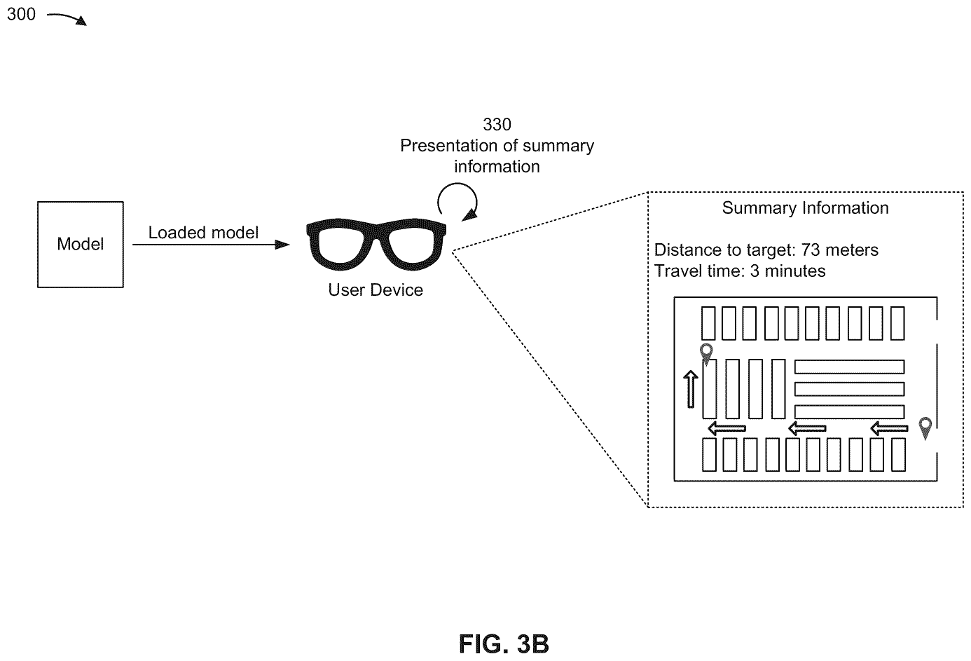

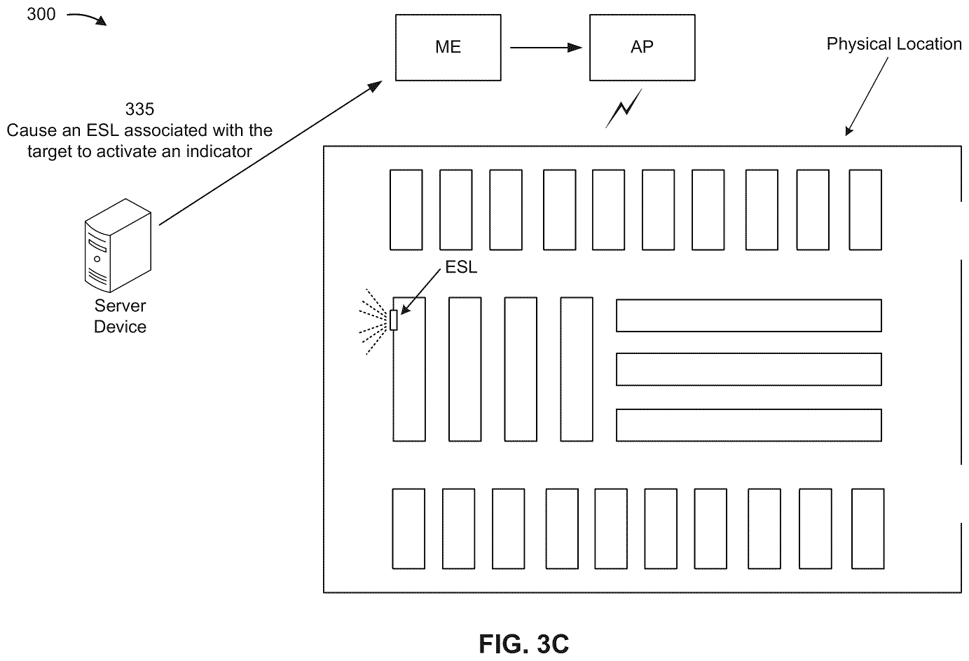

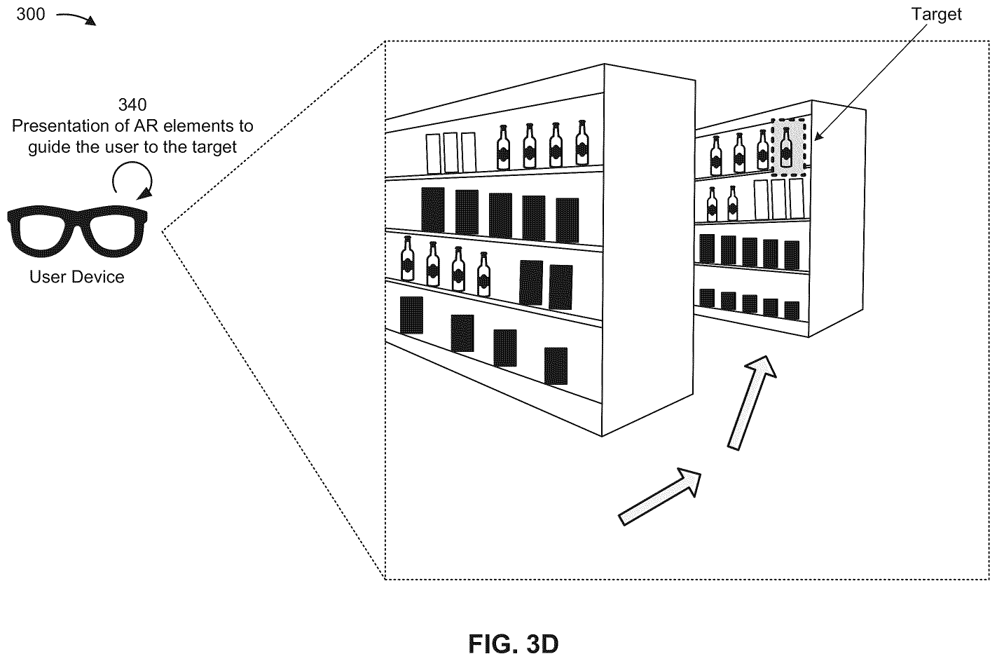

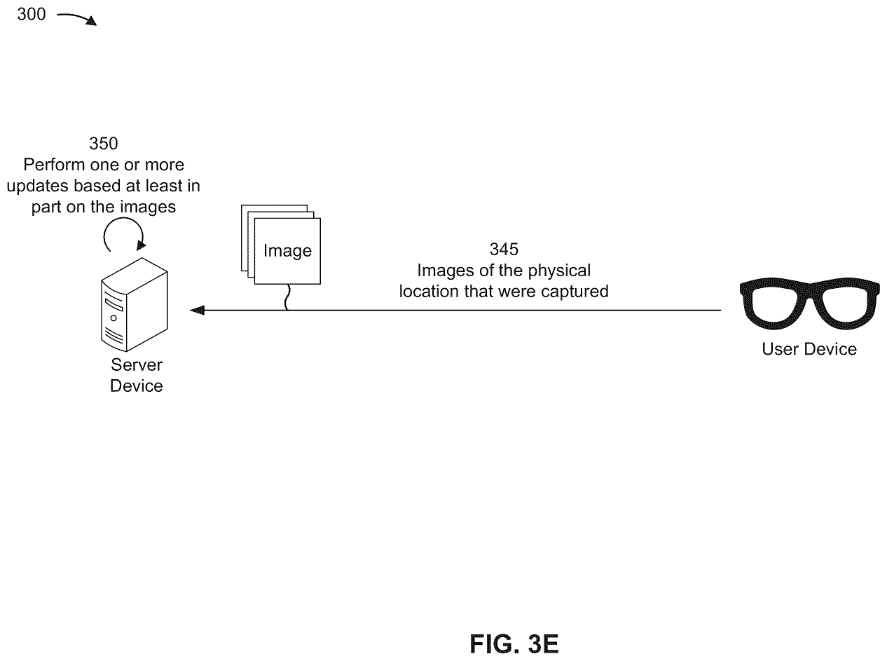

FIGS. 3A-3E are diagrams illustrating an example 300 associated with AR guidance in a physical location, in accordance with the present disclosure. As shown in FIGS. 3A-3E, example 300 includes a user device, a server device, an ME, an AP, and at least one ESL. The ME, the AP, and the ESL may be part of an ESL system.

The user device may be associated with a user. In some aspects, the user device may be an AR device (e.g., a device having a capability to present AR content), such as an HMD. In some aspects, the user device may be communicatively coupled to an AR device (e.g., using a device-to-device communication link, such as a Bluetooth link or a WiFi link), such as an HMD, that is also associated with the user. For example, the user may wear the AR device and carry the user device (e.g., in the user's pocket or hand).

The server device may be associated with a physical location, such as a retail store, an office building, a hotel, a hospital, or an airport, among other examples. The server device may be physically present at the physical location, or the server device may be remotely located from the physical location. One or more (e.g., a plurality of) ESLs may be distributed throughout the physical location. Each ESL may be associated with (e.g., may display information pertaining to) one or more items or one or more areas of the physical location. As an example, for a supermarket, a first ESL may be associated with eggs and may display information pertaining to the eggs (e.g., a brand of the eggs, a price of the eggs, etc.), a second ESL may be associated with apples and may display information pertaining to the apples, and so forth.

The server device may maintain (e.g., store and update) a plurality of models. Each model may be computer vision model trained to generate and position AR elements, for presentation on a user device, to guide a user through the physical location and/or trained to perform object recognition in connection with guiding the user through the physical location. The models may be particular to the physical location (e.g., the models are not configured to provide AR guidance in connections with locations other than the physical location). In some cases, one or more models may be particular to an item (e.g., eggs) or an area (e.g., bakery) of the physical location, or particular to a vicinity of the item or the area. For example, a model particular to a bakery area of a supermarket may be trained for object recognition in connection with various baked goods. Moreover, each model may be provisioned with information relating to items and/or areas associated with the physical location (e.g., item price information, item/area images, item promotion or discount information (e.g., including expiration information), and/or item/area ESL information, among other examples). This information may be associated with the level of particularity of the model. For example, if the model is particular to the bakery area, then the information may relate to items of the bakery area.

In some aspects, the models may be trained or updated (e.g., by the server device or another device) based at least in part on images of the physical location (e.g., that depict items and/or area of the physical location). The images may be captured by technicians, crowdsourced from visitors to the physical location, captured by autonomous rovers, and/or captured by cameras (e.g., surveillance cameras) of the physical location. In some aspects, images captured by the cameras of the physical location may be processed by the server device to validate the reliability and/or accuracy of a model.

As shown in FIG. 3A, and by reference number 305, the user device may obtain an input (e.g., from the user) indicating a target located at the physical location. The target may be an item at the physical location or an area of the physical location that is of interest to the user. As an example, for a supermarket, the target may be “eggs” or “bakery.” In some aspects, the input may further indicate an identifier of at least one ESL (e.g., a nearest or nearby ESL tag identifier). The user may provide the input to the user device as a text input, as a voice input, as a selection from multiple options, or the like.

In some aspects, the user device may obtain the input via an application (e.g., a mobile application or an HMD application) executing on the user device. The application may be particular to the physical location. For example, when the user enters the physical location, the user may use the user device to load an application associated with the physical location in order to provide the input. In some aspects, the application may cause the user device to automatically prompt the user to enter the input upon the user device entering a geofence associated with the physical location. In some aspects, the user device may prompt the user to enter the input responsive to receiving a signal (e.g., a Bluetooth signal) at the physical location. For example, the server device, or another device located at the physical location, may broadcast, or otherwise transmit, the signal to devices arriving at, entering, or in the physical location. The signal may indicate a request for the input.

In some aspects, the user device may determine a current location of the user device within the physical location. For example, the user device may determine the current location using WiFi measurements (e.g., based on respective WiFi signal strengths at the user device for one or more WiFi access points). Additionally, or alternatively, the user device may determine the current location by angle of arrival (AoA) measurement and/or BLE high accuracy distance measurement (HADM) using nearby ESLs (e.g., based at least in part on signals transmitted by the ESLs). Other location techniques may additionally, or alternatively, be used by the user device to determine the current location, such as using a global navigation satellite system (GNSS), dead reckoning, or the like.

In some aspects, the user device may obtain an image that depicts the surroundings of the user device. For example, the image may depict at least one ESL in the vicinity of the user device. In this way, the image may be used, as described below, to identify the current location of the user device according to known locations of the ESL(s) in the vicinity of the user device. The user device may obtain the image by capturing the image, or by receiving the image from an HMD communicatively coupled to the user device.

As shown by reference number 310, the user device may transmit, and the server device may receive, a message. The message may identify the target (e.g., the item or the area) that is located at the physical location (e.g., that the user inputted to the user device). Additionally, the message may include an indication of the current location of the user device within the physical location. For example, the indication of the current location may be a location identifier (e.g., geographic coordinates) as determined by the user device. As another example, the indication of the current location may be the identifier of the at least one ESL that the user inputted to the user device (e.g., a nearest or nearby ESL tag identifier). Here, the server device may identify the current location in accordance with the identifier using a mapping of ESL identifiers to ESL locations and/or by requesting location information from the ESL associated with the identifier (e.g., the server device may request the location information and receive the location information via an ME). As a further example, the indication of the current location may be the image that depicts the surroundings of the user device. Here, the server device may process the image (e.g., using a computer vision technique, such as an object recognition technique, and/or optical character recognition) to identify at least one ESL in the image and/or to obtain information relating to the ESL(s) (e.g., by extracting text, such as an identifier, that is displayed by an ESL). The server device may determine the current location in accordance with the information relating to the ESL(s), in a similar manner as described above. Additionally, or alternatively, the server device may process the image to identify one or more items in the image, and the server device may identify the current location based at least in part on information indicating locations of the items within the physical location.

In some aspects, responsive to receiving the message, the server device may cause a camera of the physical location to capture an image of the user, and the server device may process the image, in a similar manner as described above, to identify the current location of the user device. In some aspects, the server device may determine the current location of the user device using a triangulation technique based at least in part on signals from the user device detected at one or more ESLs, one or more APs, the ME, and/or the server device.

In some aspects, the user device may provide multiple messages to the server device over time (e.g., periodically) that include indications of the current location of the user device within the physical location. In some aspects, the user device may transmit the message using an application (e.g., the application particular to the physical location) executing on the user device. For example, the application may be configured to cause the user device to transmit the message to the server device (e.g., via the Internet) responsive to obtaining the input to the user device. In some aspects, the user device may transmit the message directly to the server device, such as by using low-power (local) signaling (e.g., BLE). For example, the signal indicating the request for the input (e.g., that is broadcast by the server device or the other device located at the physical location) may also indicate information to enable the user device to communicate with the server device using low-power signaling.

As shown by reference number 315, responsive to the message, the server device may prepare a model for the user device. The server device may prepare the model based at least in part on the target and/or the current location. The model may be a computer vision model.

The model may be one of a plurality of models associated with the physical location, and to prepare the model, the server device may select the model from the plurality of models (e.g., in accordance with the target and/or the current location). For example, the model may be particular to the physical location, particular to the target (e.g., particular to an item or an area, or particular to a category associated with an item or an area), and/or particular to a shelf, display, or other area that contains the target. As an example, for a supermarket, if the target is “milk,” then the model may be particular to milk, particular to dairy items, particular to milk and cereal, or the like.

The model may be configured (e.g., trained) to recognize objects in images of the physical location. For example, the model may be configured to recognize objects associated with the level of particularity of the model. As an example, if the model is particular to the target, then the model may be trained or configured to recognize the target or other objects in a category with the target (e.g., using a computer vision technique, such as an object recognition technique). Moreover, the model may be provisioned with information relating to items or areas associated with the physical location (e.g., item price information, item/area images, item promotion or discount information, and/or item/area ESL information, among other examples). The information provisioned to the model may be associated with the level of particularity of the model. For example, if the model is particular to the target, then the information may indicate price information associated with the target and/or associated with items/areas in a category with the target, images of the target and/or of items/areas in a category with the target, promotion or discount information associated with the target and/or associated with items/areas in a category with the target, and/or ESL information for ESLs associated with the target and/or associated with items/areas in a category with the target.

Additionally, or alternatively, to prepare the model, the server device may configure the model in accordance with the target and/or the current location. For example, the server device may configure (e.g., initialize) the model with information indicating a location of the target and/or the current location. Additionally, or alternatively, the server device may determine navigation instructions (e.g., directions) from the current location to the target, and the server device may configure (e.g., initialize) the model with the navigation instructions.

As shown by reference number 320, responsive to the message, the server device may transmit, and the user device may receive, the model. That is, the user device may download the model from the server device. The server device may transmit the model along with a request message requesting that the model be loaded (e.g., onto the user device or an HMD communicatively coupled to the user device) and requesting a success response from the user device. The server device may transmit the model and/or the request message to the user device via the application executing on the user device (e.g., via the Internet) and/or using low-power signaling, as described herein.

The model may be configured to cause presentation (e.g., on the user device or an AR device communicatively coupled to the user device) of one or more AR elements to guide the user through the physical location from the current location to the target. After receiving the model (e.g., after the download is complete), the user device may load the model (e.g., cause execution of the model). Alternatively, the user device may cause an AR device (e.g., an HMD), communicatively coupled to the user device, to load the model. For example, the user device may transmit the model to the AR device via a device-to-device communication link (e.g., a Bluetooth link, a WiFi link, or the like). As shown by reference number 325, responsive to receiving the model, the user device may transmit, and the server device may receive, a response message indicating whether a loading of the model (e.g., on the user device or on the HMD) is successful. The user device may transmit the response message to the server device using the application executing on the user device (e.g., via the Internet) and/or using low-power signaling, as described herein.

As shown in FIG. 3B, and by reference number 330, loading the model may cause presentation of summary information on the user device (or on an HMD communicatively coupled to the user device). The summary information may indicate the location of the target (e.g., using a map), a distance of the target from the user, an estimated time for the user to travel to the target, one or more paths (e.g., shortest paths) to the target, a price of the target, an image of the target, and/or a quality of the target, among other examples. In some aspects, the user device may locally generate the summary information (e.g., using the application particular to the physical location). In some aspects, the server device may generate the summary information, and the server device may transmit the summary information to the user device with the model and/or the server device may configure the model with the summary information. The user device may obtain an input from the user (e.g., a text input, a voice input, a selection from multiple options, or the like) indicating whether the user intends to travel to the target (e.g., the user may decide not to travel to the target if the estimated time for traveling to the target is too long) and/or indicating a selection of a path to the target. The user device may transmit information indicating the input to the server device.

As shown in FIG. 3C, and by reference number 335, the server device may cause an ESL associated with the target to activate an indicator. For example, the server device may cause the ESL to activate the indicator responsive to receiving the message identifying the target from the user device, responsive to transmitting the model to the user device, responsive to receiving the success message from the user device, and/or responsive to receiving information indicating that the user intends to travel to the target from the user device. In some aspects, the server device may delay causing the ESL to activate the indicator until the user device reports, to the server device, a current location that is within a threshold distance of the ESL. Activating the indicator of the ESL facilitates faster location of the target. Accordingly, the user device may conserve computing resources that it may have otherwise expended capturing and processing camera data for an extended time period.

The ESL associated with the target may be attached to a shelf, a rack, a display, or the like where the target is located (e.g., if the target is an item), or attached to an entrance, a doorway, a wall, or the like where the target is located (e.g., if the target is an area). The ESL may include a display, one or more light sources (e.g., light emitting diodes (LEDs)), and/or one or more speakers, among other examples. In some aspects, the indicator of the ESL may be a visual indicator, such as an illuminated light, a blinking light, and/or a change of color and/or illumination on the display (e.g., of a background or a foreground, such as text), among other examples. Additionally, or alternatively, the indicator of the ESL may be an audible indicator, such as a beeping sound, among other examples.

To cause the ESL to activate the indicator, the server device may transmit a command to activate the indicator of the ESL to an ME device associated with (e.g., that controls) the ESL. The ME device may transmit the command to an AP, and the AP, in turn, may forward the command to the ESL. In some aspects, the server device may implement an ME associated with (e.g., that controls) the ESL. Here, to cause the ESL to activate the indicator, the server device may transmit a command to activate the indicator of the ESL to an AP, and the AP, in turn, may forward the command to the ESL.

As shown in FIG. 3D, and by reference number 340, the user device (or an HMD communicatively coupled to the user device), executing the model, may present AR elements that guide the user through the physical location from the current location to the target. In some aspects, the guidance of the user through the physical location, that is enabled by the model, may be unassisted by the server device. In other words, after the server device provides the model to the user device, the user device may use the model to guide the user to the target without further assistance from the server device.

The AR elements may include arrows that point out a path to the target and/or one or more instructions (e.g., “turn left at the next aisle”), among other examples. The AR elements may update in real time as the current location of the user/user device changes. The user device (or an AR device communicatively coupled to the user device) may capture images (e.g., video) of the physical location as the user moves through the physical location, and the user device may provide the images to the model to enable the model to generate and position the AR elements for guiding the user through the physical location. The user device (or the HMD) may capture the images using a camera.

One or more of the captured images may depict the target (e.g., as the user approaches the target). In some aspects, the user device, using the model, may perform object recognition on the images to identify the target, or a vicinity of the target (e.g., a shelf on which the target is located), in one or more images. Here, an AR element that is presented may include a distinguishing element that is an overlay on the target or the vicinity. For example, the distinguishing element may include a rectangle, a circle, a highlighting color, and/or a glowing effect, among other examples, that distinguishes (e.g., accentuates) the target or the vicinity from a remainder of a scene.

In some aspects, as shown by reference number 345, the user device may transmit, and the server device may receive, one or more images of the physical location that were captured as the user travels through the physical location. Thus, the images may depict items (e.g., including packaging of the items, labels of the items, or the like) and/or areas of the physical location, associated with the target or otherwise. In addition, the images may depict ESLs associated with the items and/or areas (e.g., which may display prices, discounts, or the like). In some examples, the images may depict shelving or other displays, and/or the images may depict one or more people.

As shown by reference number 350, the server device may perform one or more updates (e.g., in real time) based at least in part on the images. In some aspects, the server device may perform object recognition and/or optical character recognition on the images to identify the ESLs as well as the items, areas, displays, and/or people. Based at least in part on the images (e.g., the ESLs, items, areas, displays, and/or people identified in the images), the server device may update the model, update a different model, update information indicating ESL locations, update ESL information (e.g., if an image depicts an ESL displaying incorrect information), and/or update information indicating associations between ESLs and items/areas, among other examples.

In some aspects, an image may depict that an ESL is inactive (e.g., turned off), and the server device may transmit (e.g., to an ME device, or to an access point if the server device is the ME device) a command to activate the ESL, may transmit a maintenance request for the ESL, may perform troubleshooting of the ESL, or may cause another device (e.g., the ME device) to perform troubleshooting of the ESL. In some aspects, based at least in part on a number of people in a particular area, as depicted in one or more images, the server device may perform operations to manage crowdsourcing of images. For example, if the images depict a threshold number of people, then the server device may indicate to one or more user devices to stop capturing and/or transmitting images to the server device. As another example, if the images depict less than the threshold number of people, then the server device may indicate to one or more user devices to initiate capturing and/or transmitting images to the server device.

The user device may use the model for navigating the physical location until the model expires (e.g., which may be after 30 minutes, after an hour, or the like) or until the user requests a different target (and the user device may discard the model). Thus, if the user leaves the physical location and re-enters the physical location after the model has expired, then the user device may download a new model from the server device, as described herein. Similarly, if the user requests a different target, then the user device may download a new model from the server device, as described herein. Moreover, if the user enters a different physical location, then the user device may download a model associated with the different physical location, as described herein. In this way, the user device may obtain a fresh model each time the user visits a physical location and/or requests a new target, thereby improving the efficiency and the accuracy of the AR guidance and reducing a storage burden on the user device.

As indicated above, FIGS. 3A-3E are provided as an example. Other examples may differ from what is described with respect to FIGS. 3A-3E.

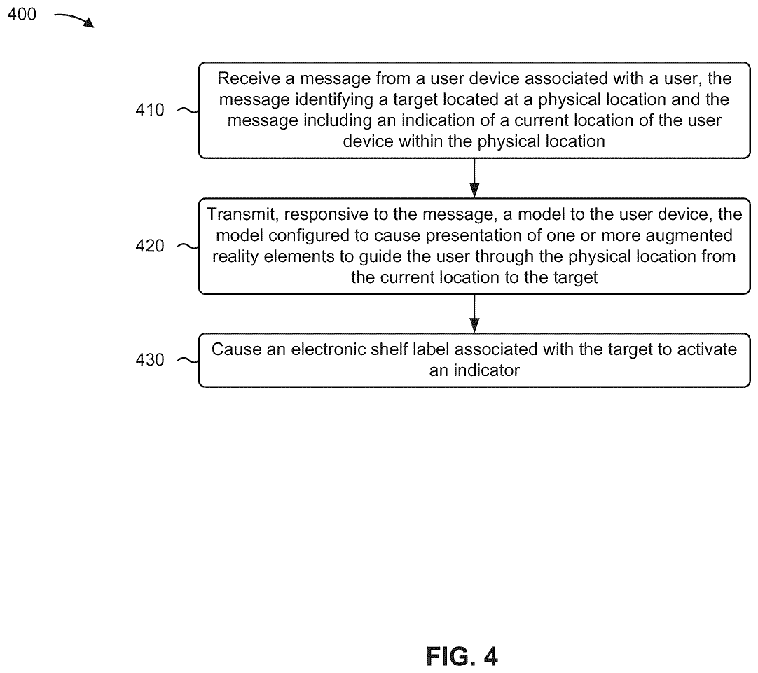

FIG. 4 is a flowchart of an example process 400 associated with AR guidance in a physical location. In some implementations, one or more process blocks of FIG. 4 are performed by a server device (e.g., server device 120). In some implementations, one or more process blocks of FIG. 4 are performed by another device or a group of devices separate from or including the server device, such as a user device (e.g., user device 110), an ME device (e.g., ME device 130), an APP (e.g., AP 140), and/or an ESL (e.g., ESL 150). Additionally, or alternatively, one or more process blocks of FIG. 4 may be performed by one or more components of device 200, such as processor 210, memory 215, input component 220, output component 225, communication component 230, and/or sensor 235.

As shown in FIG. 4, process 400 may include receiving a message from a user device associated with a user, the message identifying a target located at a physical location and the message including an indication of a current location of the user device within the physical location (block 410). For example, the server device associated with a physical location may receive a message from a user device associated with a user, as described above. In some aspects, the message may identify a target located at the physical location and the message may include an indication of a current location of the user device within the physical location.

As further shown in FIG. 4, process 400 may include transmitting, responsive to the message, a model to the user device, the model configured to cause presentation of one or more augmented reality elements to guide the user through the physical location from the current location to the target (block 420). For example, the server device may transmit, responsive to the message, a model to the user device, as described above. In some aspects, the model may be configured to cause presentation of one or more augmented reality elements to guide the user through the physical location from the current location to the target.

As further shown in FIG. 4, process 400 may include causing an ESL associated with the target to activate an indicator (block 430). For example, the server device may cause an ESL associated with the target to activate an indicator, as described above.

Process 400 may include additional implementations, such as any single implementation or any combination of implementations described below and/or in connection with one or more other processes described elsewhere herein.

In a first implementation, process 400 includes receiving, from the user device, a response message indicating whether a loading of the model is successful.

In a second implementation, alone or in combination with the first implementation, causing the ESL associated with the target to activate the indicator includes transmitting, to a management entity device associated with the ESL, a command to activate the indicator of the ESL.

In a third implementation, alone or in combination with one or more of the first and second implementations, the model is to be loaded on the user device or on an augmented reality device that has a device-to-device communication link with the user device.

In a fourth implementation, alone or in combination with one or more of the first through third implementations, the model is one of a plurality of models associated with the physical location, and the model is particular to the target.

In a fifth implementation, alone or in combination with one or more of the first through fourth implementations, the model is further configured to recognize objects in images of the physical location.

In a sixth implementation, alone or in combination with one or more of the first through fifth implementations, guidance of the user through the physical location from the current location to the target, that is enabled by the model, is unassisted by the server device.

In a seventh implementation, alone or in combination with one or more of the first through sixth implementations, the target is an item at the physical location or an area of the physical location.

In an eighth implementation, alone or in combination with one or more of the first through seventh implementations, process 400 includes receiving, from the user device, one or more images of the physical location, and updating the model based at least in part on the one or more images.

In a ninth implementation, alone or in combination with one or more of the first through eighth implementations, the indication of the current location includes an image that depicts at least one ESL.

In a tenth implementation, alone or in combination with one or more of the first through ninth implementations, process 400 includes processing the image to obtain information relating to the at least one ESL, and determining the current location in accordance with the information.

In an eleventh implementation, alone or in combination with one or more of the first through tenth implementations, the indication of the current location includes an identifier of at least one ESL.

In a twelfth implementation, alone or in combination with one or more of the first through eleventh implementations, the indicator is a blinking light.

Although FIG. 4 shows example blocks of process 400, in some

implementations, process 400 includes additional blocks, fewer blocks, different blocks, or differently arranged blocks than those depicted in FIG. 4. Additionally, or alternatively, two or more of the blocks of process 400 may be performed in parallel.

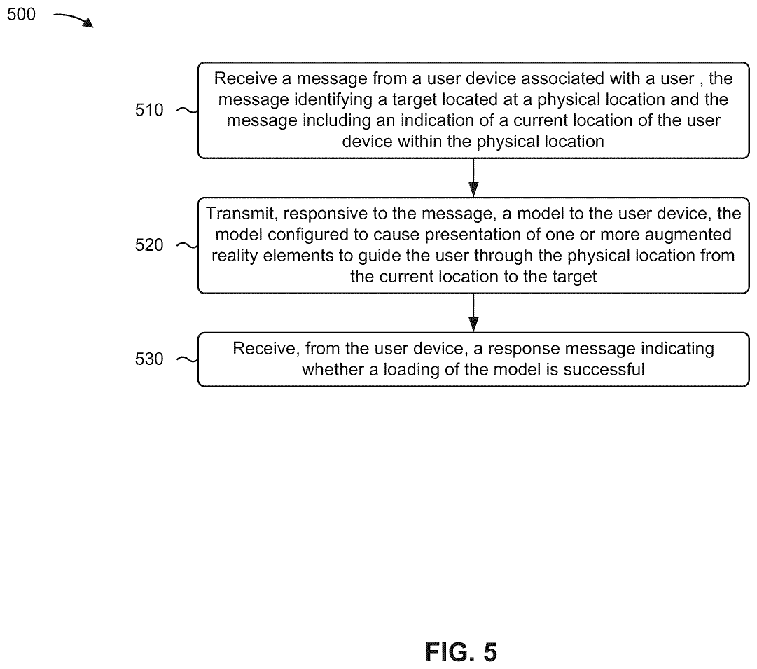

FIG. 5 is a flowchart of an example process 500 associated with AR guidance in a physical location. In some implementations, one or more process blocks of FIG. 5 are performed by a server device (e.g., server device 120). In some implementations, one or more process blocks of FIG. 5 are performed by another device or a group of devices separate from or including the server device, such as a user device (e.g., user device 110), an ME device (e.g., ME device 130), an APP (e.g., AP 140), and/or an ESL (e.g., ESL 150). Additionally, or alternatively, one or more process blocks of FIG. 5 may be performed by one or more components of device 200, such as processor 210, memory 215, input component 220, output component 225, communication component 230, and/or sensor 235.

As shown in FIG. 5, process 500 may include receiving a message from a user device associated with a user, the message identifying a target located at a physical location and the message including an indication of a current location of the user device within the physical location (block 510). For example, the server device may receive a message from a user device associated with a user, as described above. In some aspects, the message may identify a target located at a physical location and the message may include an indication of a current location of the user device within the physical location.

As further shown in FIG. 5, process 500 may include transmitting, responsive to the message, a model to the user device, the model configured to cause presentation of one or more augmented reality elements to guide the user through the physical location from the current location to the target (block 520). For example, the server device may transmit, responsive to the message, a model to the user device, as described above. In some aspects, the model may be configured to cause presentation of one or more augmented reality elements to guide the user through the physical location from the current location to the target.

As further shown in FIG. 5, process 500 may include receiving, from the user device, a response message indicating whether a loading of the model is successful (block 530). For example, the server device may receive, from the user device, a response message indicating whether a loading of the model is successful, as described above.

Process 500 may include additional implementations, such as any single implementation or any combination of implementations described below and/or in connection with one or more other processes described elsewhere herein.

In a first implementation, process 500 includes causing an electronic shelf label associated with the target to activate an indicator.

In a second implementation, alone or in combination with the first implementation, the one or more augmented reality elements include a distinguishing element that is an overlay on the target.

In a third implementation, alone or in combination with one or more of the first and second implementations, the model is to be loaded on the user device or on an augmented reality device that has a device-to-device communication link with the user device.

In a fourth implementation, alone or in combination with one or more of the first through third implementations, the model is one of a plurality of models associated with the physical location, and the model is particular to the target.

In a fifth implementation, alone or in combination with one or more of the first through fourth implementations, the model is further configured to recognize objects in images of the physical location.

In a sixth implementation, alone or in combination with one or more of the first through fifth implementations, the target is an item at the physical location or an area of the physical location.

In a seventh implementation, alone or in combination with one or more of the first through sixth implementations, the indication of the current location includes an image that depicts at least one ESL.

In an eighth implementation, alone or in combination with one or more of the first through seventh implementations, process 500 includes processing the image to obtain information relating to the at least one ESL, and determining the current location in accordance with the information.

In a ninth implementation, alone or in combination with one or more of the first through eighth implementations, the message is in signaling between the device and the user device.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

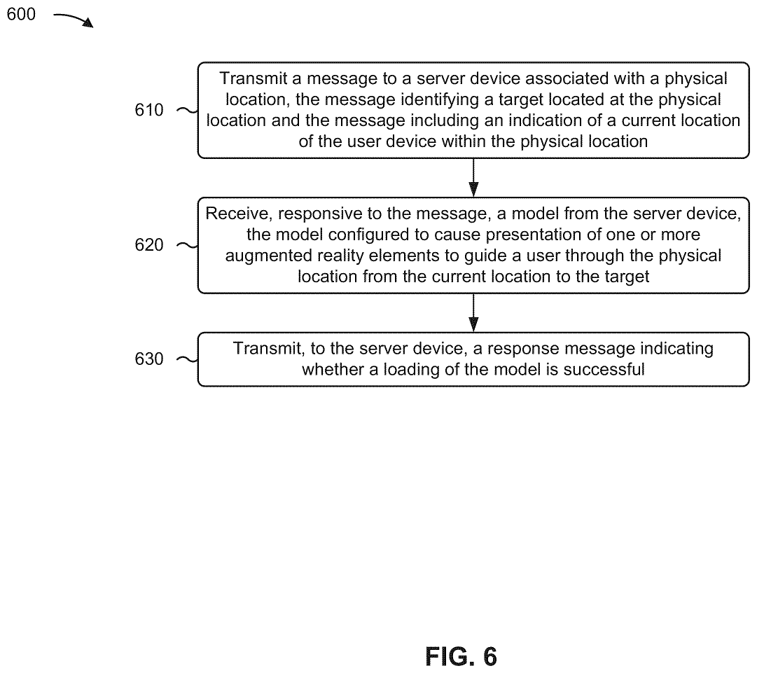

FIG. 6 is a flowchart of an example process 600 associated with AR guidance in a physical location. In some implementations, one or more process blocks of FIG. 6 are performed by a user device (e.g., user device 110). In some implementations, one or more process blocks of FIG. 6 are performed by another device or a group of devices separate from or including the user device, such as a server device (e.g., server device 120), an ME device (e.g., ME device 130), an AP (e.g., AP 140), and/or an ESL (e.g., ESL 150). Additionally, or alternatively, one or more process blocks of FIG. 6 may be performed by one or more components of device 200, such as processor 210, memory 215, input component 220, output component 225, communication component 230, and/or sensor 235.

As shown in FIG. 6, process 600 may include transmitting a message to a server device associated with a physical location, the message identifying a target located at the physical location and the message including an indication of a current location of the user device within the physical location (block 610). For example, the user device may transmit a message to a server device associated with a physical location, as described above. In some aspects, the message may identify a target located at the physical location and the message including an indication of a current location of the user device within the physical location.

As further shown in FIG. 6, process 600 may include receiving, responsive to the message, a model from the server device, the model configured to cause presentation of one or more augmented reality elements to guide a user through the physical location from the current location to the target (block 620). For example, the user device may receive, responsive to the message, a model from the server device, as described above. In some aspects, the model may be configured to cause presentation of one or more augmented reality elements to guide a user through the physical location from the current location to the target.

As further shown in FIG. 6, process 600 may include transmitting, to the server device, a response message indicating whether a loading of the model is successful (block 630). For example, the user device may transmit, to the server device, a response message indicating whether a loading of the model is successful, as described above.

Process 600 may include additional implementations, such as any single implementation or any combination of implementations described below and/or in connection with one or more other processes described elsewhere herein.

In a first implementation, the model is to be loaded on the user device or on an augmented reality device that has a device-to-device communication link with the user device.

In a second implementation, alone or in combination with the first implementation, guidance of the user through the physical location from the current location to the target, that is enabled by the model, is to be unassisted by the server device.

In a third implementation, alone or in combination with one or more of the first and second implementations, the indication of the current location includes an image that depicts at least one ESL.

In a fourth implementation, alone or in combination with one or more of the first through third implementations, the indication of the current location includes an identifier of at least one ESL.

Although FIG. 6 shows example blocks of process 600, in some implementations, process 600 includes additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:
Aspect 1: A method, comprising: receiving, by a server device associated with a physical location, a message from a user device associated with a user, the message identifying a target located at the physical location and the message including an indication of a current location of the user device within the physical location; transmitting, by the server device and responsive to the message, a model to the user device, the model configured to cause presentation of one or more augmented reality elements to guide the user through the physical location from the current location to the target; and causing, by the server device, an electronic shelf label (ESL) associated with the target to activate an indicator.
Aspect 2: The method of Aspect 1, further comprising: receiving, from the user device, a response message indicating whether a loading of the model is successful.
Aspect 3: The method of any of Aspects 1-2, wherein causing the ESL associated with the target to activate the indicator comprises: transmitting, to a management entity device associated with the ESL, a command to activate the indicator of the ESL.
Aspect 4: The method of any of Aspects 1-3, wherein the model is to be loaded on the user device or on an augmented reality device that has a device-to-device communication link with the user device.
Aspect 5: The method of any of Aspects 1-4, wherein the model is one of a plurality of models associated with the physical location, and wherein the model is particular to the target.
Aspect 6: The method of any of Aspects 1-5, wherein the model is further configured to recognize objects in images of the physical location.
Aspect 7: The method of any of Aspects 1-6, wherein guidance of the user through the physical location from the current location to the target, that is enabled by the model, is unassisted by the server device.
Aspect 8: The method of any of Aspects 1-7, wherein the target is an item at the physical location or an area of the physical location.
Aspect 9: The method of any of Aspects 1-8, further comprising: receiving, from the user device, one or more images of the physical location; and updating the model based at least in part on the one or more images.
Aspect 10: The method of any of Aspects 1-9, wherein the indication of the current location comprises an image that depicts at least one ESL.
Aspect 11: The method of Aspect 10, further comprising: processing the image to obtain information relating to the at least one ESL; and determining the current location in accordance with the information.
Aspect 12: The method of any of Aspects 1-11, wherein the indication of the current location comprises an identifier of at least one ESL.
Aspect 13: The method of any of Aspects 1-12, wherein the indicator is a blinking light.
Aspect 14: A device, comprising: one or more memories; and one or more processors, coupled to the one or more memories, configured to: receive a message from a user device associated with a user, the message identifying a target located at a physical location and the message including an indication of a current location of the user device within the physical location; transmit, responsive to the message, a model to the user device, the model configured to cause presentation of one or more augmented reality elements to guide the user through the physical location from the current location to the target; and receive, from the user device, a response message indicating whether a loading of the model is successful.
Aspect 15: The device of Aspect 14, wherein the one or more processors are further configured to: cause an electronic shelf label associated with the target to activate an indicator.
Aspect 16: The device of any of Aspects 14-15, wherein the one or more augmented reality elements include a distinguishing element that is an overlay on the target.
Aspect 17: The device of any of Aspects 14-16, wherein the model is to be loaded on the user device or on an augmented reality device that has a device-to-device communication link with the user device.
Aspect 18: The device of any of Aspects 14-17, wherein the model is one of a plurality of models associated with the physical location, and wherein the model is particular to the target.
Aspect 19: The device of any of Aspects 14-18, wherein the model is further configured to recognize objects in images of the physical location.
Aspect 20: The device of any of Aspects 14-19, wherein the target is an item at the physical location or an area of the physical location.
Aspect 21: The device of any of Aspects 14-20, wherein the indication of the current location comprises an image that depicts at least one ESL.
Aspect 22: The device of Aspect 21, wherein the one or more processors are further configured to: process the image to obtain information relating to the at least one ESL; and determine the current location in accordance with the information.
Aspect 23: The device of any of Aspects 14-22, wherein the message is in signaling between the device and the user device.
Aspect 24: An apparatus, comprising: means for receiving a message from a user device associated with a user, the message identifying a target located at a physical location and the message including an indication of a current location of the user device within the physical location; and means for transmitting, responsive to the message, a model to the user device, the model configured to cause presentation of one or more augmented reality elements to guide the user through the physical location from the current location to the target.
Aspect 25: The apparatus of Aspect 24, further comprising: means for causing an electronic shelf label associated with the target to activate an indicator.
Aspect 26: A non-transitory computer-readable medium storing a set of instructions, the set of instructions comprising: one or more instructions that, when executed by one or more processors of a user device, cause the user device to: transmit a message to a server device associated with a physical location, the message identifying a target located at the physical location and the message including an indication of a current location of the user device within the physical location; receive, responsive to the message, a model from the server device, the model configured to cause presentation of one or more augmented reality elements to guide a user through the physical location from the current location to the target; and transmit, to the server device, a response message indicating whether a loading of the model is successful.
Aspect 27: The non-transitory computer-readable medium of Aspect 26, wherein the model is to be loaded on the user device or on an augmented reality device that has a device-to-device communication link with the user device.
Aspect 28: The non-transitory computer-readable medium of any of Aspects 26-27, wherein guidance of the user through the physical location from the current location to the target, that is enabled by the model, is to be unassisted by the server device.
Aspect 29: The non-transitory computer-readable medium of any of Aspects 26-28, wherein the indication of the current location comprises an image that depicts at least one ESL.
Aspect 30: The non-transitory computer-readable medium of any of Aspects 26-29, wherein the indication of the current location comprises an identifier of at least one ESL.
Aspect 31: A system configured to perform one or more operations recited in one or more of Aspects 1-30.
Aspect 32: An apparatus comprising means for performing one or more operations recited in one or more of Aspects 1-30.
Aspect 33: A non-transitory computer-readable medium storing a set of instructions, the set of instructions comprising one or more instructions that, when executed by a device, cause the device to perform one or more operations recited in one or more of Aspects 1-30.
Aspect 34: A computer program product comprising instructions or code for executing one or more operations recited in one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a server device associated with a physical location, a message from a user device associated with a user,
the message identifying a target located at the physical location and the message including an indication of a current location of the user device within the physical location;
transmitting, by the server device and responsive to the message, a model to the user device,
the model configured to cause presentation of one or more augmented reality elements to guide the user through the physical location from the current location to the target; and
causing, by the server device, an electronic shelf label (ESL) associated with the target to activate an indicator.

2. The method of claim 1, further comprising:
receiving, from the user device, a response message indicating whether a loading of the model is successful.

3. The method of claim 1, wherein causing the ESL associated with the target to activate the indicator comprises:
transmitting, to a management entity device associated with the ESL, a command to activate the indicator of the ESL.

4. The method of claim 1, wherein the model is to be loaded on the user device or on an augmented reality device that has a device-to-device communication link with the user device.

5. The method of claim 1, wherein the model is one of a plurality of models associated with the physical location, and
wherein the model is particular to the target.

6. The method of claim 1, wherein the model is further configured to recognize objects in images of the physical location.

7. The method of claim 1, wherein guidance of the user through the physical location from the current location to the target, that is enabled by the model, is unassisted by the server device.

8. The method of claim 1, wherein the target is an item at the physical location or an area of the physical location.

9. The method of claim 1, further comprising:
receiving, from the user device, one or more images of the physical location; and
updating the model based at least in part on the one or more images.

10. The method of claim 1, wherein the indication of the current location comprises an image that depicts at least one ESL.

11. The method of claim 10, further comprising:
processing the image to obtain information relating to the at least one ESL; and
determining the current location in accordance with the information.

12. The method of claim 1, wherein the indication of the current location comprises an identifier of at least one ESL.

13. The method of claim 1, wherein the indicator is a blinking light.

14. A device, comprising:
one or more memories; and
one or more processors, coupled to the one or more memories, configured to:
receive a message from a user device associated with a user,
the message identifying a target located at a physical location and the message including an indication of a current location of the user device within the physical location;
transmit, responsive to the message, a model to the user device,
the model configured to cause presentation of one or more augmented reality elements to guide the user through the physical location from the current location to the target; and
receive, from the user device, a response message indicating whether a loading of the model is successful.

15. The device of claim 14, wherein the one or more processors are further configured to:
cause an electronic shelf label associated with the target to activate an indicator.

16. The device of claim 14, wherein the one or more augmented reality elements include a distinguishing element that is an overlay on the target.

17. The device of claim 14, wherein the model is to be loaded on the user device or on an augmented reality device that has a device-to-device communication link with the user device.

18. The device of claim 14, wherein the model is one of a plurality of models associated with the physical location, and
wherein the model is particular to the target.

19. The device of claim 14, wherein the model is further configured to recognize objects in images of the physical location.

20. The device of claim 14, wherein the target is an item at the physical location or an area of the physical location.

21. The device of claim 14, wherein the indication of the current location comprises an image that depicts at least one ESL.

22. The device of claim 21, wherein the one or more processors are further configured to:
process the image to obtain information relating to the at least one ESL; and
determine the current location in accordance with the information.

23. The device of claim 14, wherein the message is in signaling between the device and the user device.

24. An apparatus, comprising:
means for receiving a message from a user device associated with a user,
the message identifying a target located at a physical location and the message including an indication of a current location of the user device within the physical location; and
means for transmitting, responsive to the message, a model to the user device,
the model configured to cause presentation of one or more augmented reality elements to guide the user through the physical location from the current location to the target.

25. The apparatus of claim 24, further comprising:
means for causing an electronic shelf label associated with the target to activate an indicator.

26. A non-transitory computer-readable medium storing a set of instructions, the set of instructions comprising:
one or more instructions that, when executed by one or more processors of a user device, cause the user device to:
transmit a message to a server device associated with a physical location,
the message identifying a target located at the physical location and the message including an indication of a current location of the user device within the physical location;
receive, responsive to the message, a model from the server device,
the model configured to cause presentation of one or more augmented reality elements to guide a user through the physical location from the current location to the target; and
transmit, to the server device, a response message indicating whether a loading of the model is successful.

27. The non-transitory computer-readable medium of claim 26, wherein the model is to be loaded on the user device or on an augmented reality device that has a device-to-device communication link with the user device.

28. The non-transitory computer-readable medium of claim 26, wherein guidance of the user through the physical location from the current location to the target, that is enabled by the model, is to be unassisted by the server device.

29. The non-transitory computer-readable medium of claim 26, wherein the indication of the current location comprises an image that depicts at least one ESL.

30. The non-transitory computer-readable medium of claim 26, wherein the indication of the current location comprises an identifier of at least one ESL.
